(19) United States
(12) Patent Application Publication
(10) Pub. No.: US 2015/0367503 A1
(43) Pub. Date: Dec. 24, 2015

(54) SCREWDRIVER HEAD STORAGE DEVICE

(71) Applicant: SIMON LIU, Taichung City (TW)

(72) Inventor: SIMON LIU, Taichung City (TW)

(21) Appl. No.: 14/312,605

(22) Filed: Jun. 23, 2014

(51) Int. Cl. B25H 3/00

(52) U.S. Cl. CPC B25H 3/003

(57) ABSTRACT

A screwdriver head storage device includes a cover and a base formed with a plurality of inner spaces which includes a bottom and a top. The cover includes a stop flange, a push portion, and a lateral opening on the top of the inner spaces. Each of the elastic members is received in a corresponding one of the inner spaces and has a first end connected to the bottom of the corresponding one of the positioning portions. Each of the inner spaces is capable of holding a plurality of screwdriver heads between a top surface of the base member and a second end of the respective elastic members. The screwdriver head can be taken out via a lateral opening, then the compression spring will push the rest screwdriver heads toward the top of the inner space until the screwdriver heads are stopped against the stop flange.

### BACKGROUND OF THE INVENTION

1. Field of the Invention

The present invention relates to a screwdriver head storage device, and more particularly to a screwdriver head storage device which is capable of storing and display screwdriver heads, and convenient to use.

2. Description of the Prior Art

A conventional screwdriver head storage device shown in FIG. 1 comprises: a storage box 10 which is divided into a plurality of chambers 12 by a plurality of separating pieces 11, so that screwdriver heads 15 can be held in the chambers 12, and the specification of the screwdriver heads 15 can be seen through the gaps 13 of the chambers 12.

However, the disadvantage of this conventional screwdriver head storage device is that each of the chambers 12 is capable of holding only a single screwdriver head 15. Especially when the storage device is used as a case to display the screwdriver heads 15, the user has to replenish new screwdriver heads 15 very frequently. If the chamber 12 is deepened to accommodate more screwdriver heads 15, then the one located at the bottom of the chamber 12 is difficult to take out.

The present invention has arisen to mitigate and/or obviate the afore-described disadvantages.

### SUMMARY OF THE INVENTION

The primary objective of the present invention is to provide a screwdriver head storage device which is provided with a plurality of inner spaces, each inner space is capable of holding a plurality of screwdriver heads, and the screwdriver heads are easy to take out.

To achieve the above objective, a screwdriver head storage device in accordance with the present invention comprises: a base and a plurality of elastic members. The base is formed with a plurality of chambers, each of the inner spaces includes a bottom and a top, the cover being provided with a stop flange, a push portion, and a lateral opening on the top of each of the inner spaces. Each of the elastic members is received in a corresponding one of the inner spaces and has a first end connected to the bottom of the corresponding one of the positioning portions. Each of the inner spaces is capable of holding a plurality of screwdriver heads between a top surface of the base member and a second end of the respective elastic members.

A plurality of different sized screwdriver heads can be in the same inner space, and the user can take out the screwdriver head via the lateral opening When the screwdriver head is taken out, the compression spring will push the rest screwdriver heads toward the top of the inner space until the screwdriver heads are stopped against the stop flange. Therefore, the screwdriver head storage device of the present invention is convenient to use, and the user does not have to replenish new screwdriver heads very frequently, when the screwdriver head storage device is used as a display case.

### BRIEF DESCRIPTION OF THE DRAWINGS

FIG. 1 is a perspective view of a conventional screwdriver head storage device;

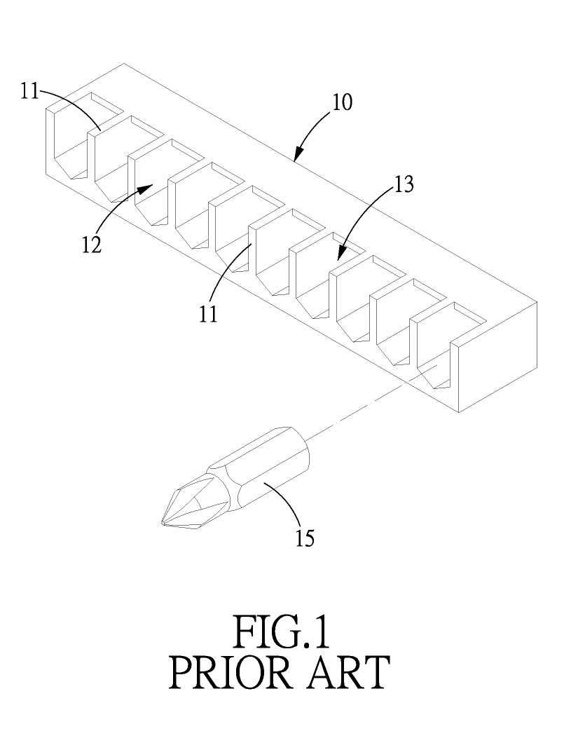

FIG. 2 shows a screwdriver head storage device in accordance with a preferred embodiment of the present invention;

FIG. 3 is an exploded view of the screwdriver head storage device in accordance with the preferred embodiment of the present invention;

FIG. 4 is a cross sectional view of the screwdriver head storage device in accordance with the present invention; and

FIG. 5 is another cross sectional view of the screwdriver head storage device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

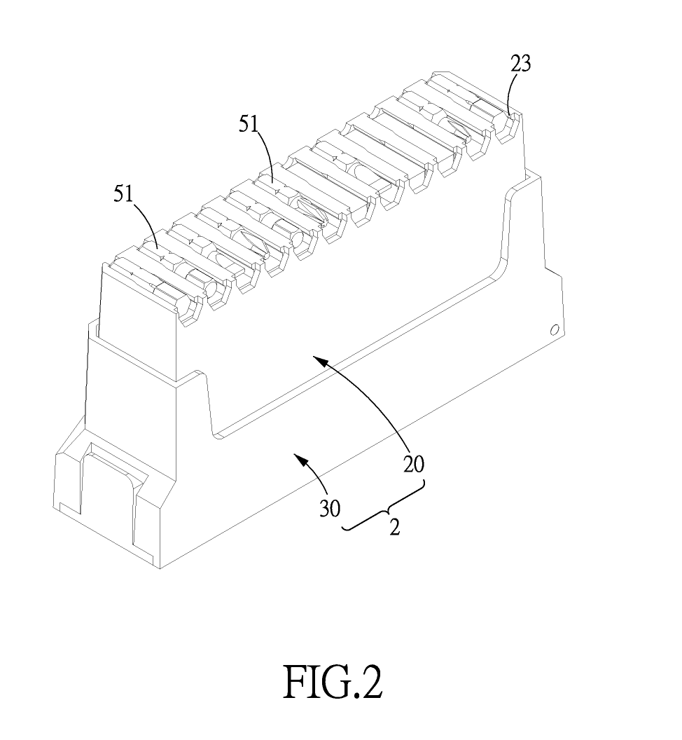

Referring to FIGS. 2-4, a screwdriver head storage device in accordance with a preferred embodiment of the present invention comprises: a base 2 and a plurality of elastic members 40.

The base 2 includes a cover 20 fixed to a top surface of a base member 30. The cover 20 is divided into a plurality of chambers by a plurality of separating pieces 21. When the cover 20 is fixed to the base member 30, the chambers of the cover 20 are sealed with the top surface of the base member 30 to form a plurality of inner spaces 22. Each of the inner spaces 22 includes a bottom which is the top surface of the base member 30, and a top which is the top surface of the cover 20. The cover 20 is provided with a stop flange 23, a push portion 24, and a lateral opening 25 on the top of each of the inner spaces 22. The stop flange 23 is located at two sides of the push portion 24. The base member 30 is provided at a bottom surface thereof with a base chamber 31, and a pivot member 32 which is pivoted at one side of the base chamber 31 to selectively close or open the base chamber 31. The base member 30 is provided at the top surface thereof with a plurality of positioning portions 33.

Each of the elastic members 40 is received in a corresponding one of the inner spaces 22 and has a first end connected to a corresponding one of the positioning portions 33. In this embodiment, each of the elastic members 40 includes a compression spring 41 and a push member 42 fixed to one end of the compression spring 41, another end of the compression spring 41 is sleeved onto the positioning portion 33, and a lateral flat surface 421 of the push member 42 is abutted against the top surface of the inner space 22.

Each of the inner spaces 22 is capable of holding a plurality of screwdriver heads 51 between the top surface of the base 2 and a second end of the respective elastic members 40, in such a manner that the screwdriver heads 51 are pushed toward the top of the inner spaces 22 by the elastic members 40 and stopped against the stop flanges 23.

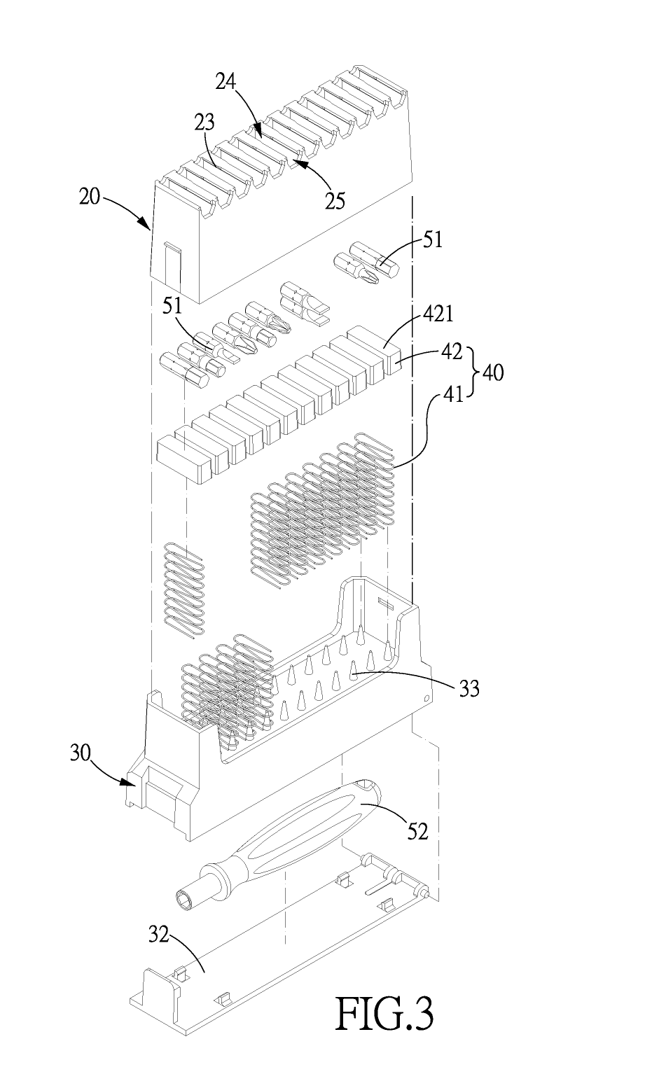

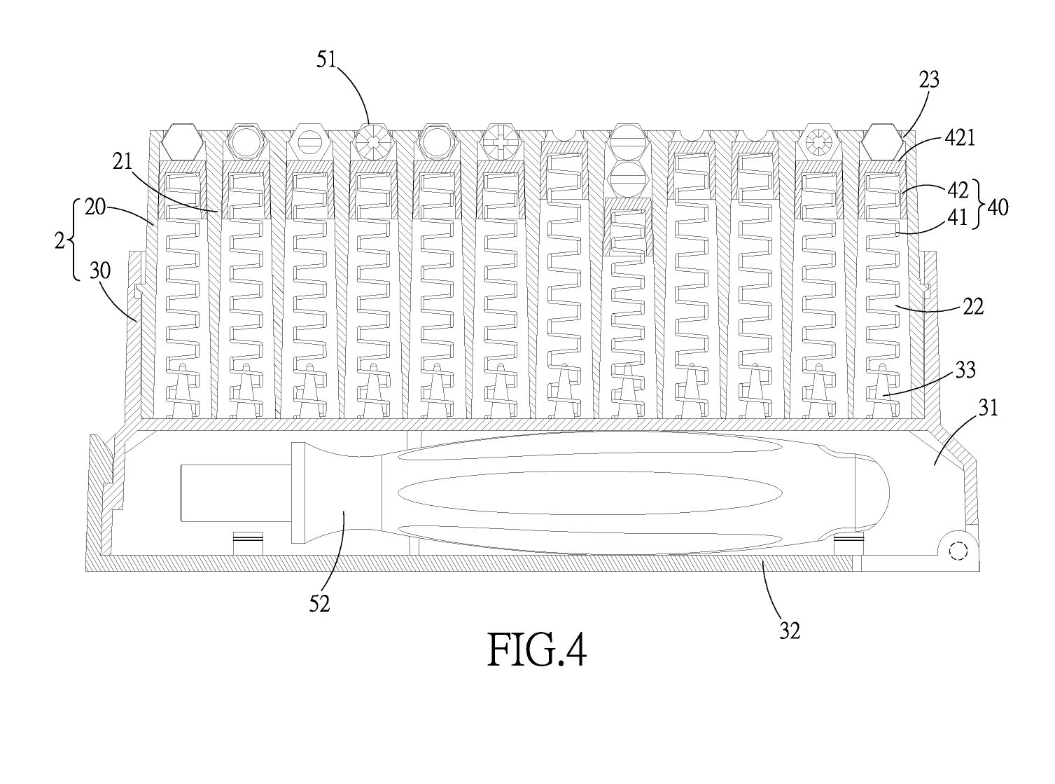

What mentioned above are the structures of the present invention, for a better understanding of the invention, its operating advantages and the specific objects attained by its uses, reference should be had to FIGS. 4 and 3 and the following descriptive matter. Each of the elastic members 40 has the lateral flat surface 421 of the push member 42 abutted against the top surface of the inner space 22 in the first place, more specifically abutted against the stop flange 23.

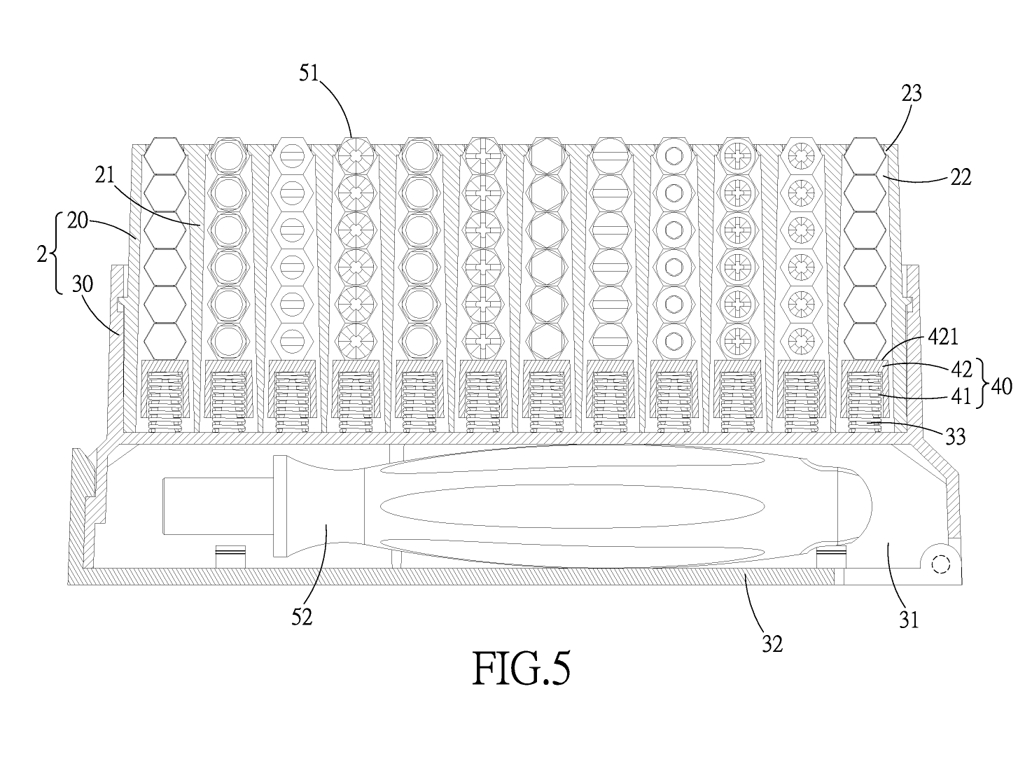

When in use, as shown in FIGS. 5 and 3, (for easy description, only one inner space 22 is introduced) a plurality of different sized screwdriver heads 51 can be in the same inner space 22, and at this moment, the compression spring 41 of the elastic member 40 in the inner space 22 is compressed.

If the user wants to take out one of the screwdriver heads 51, he/she can push the screwdriver head 51 partially out of the inner space 22 via the push portion 24 of the cover 20, then pull the screwdriver head 51 out of the inner space 22 via the lateral opening 25 by gripping the part of the screwdriver head 51 protruding out of the inner space 22. When the screwdriver head 51 is taken out, the compression spring 41 will push the rest screwdriver heads 51 toward the top of the inner space 22 until the screwdriver heads 51 are stopped against the stop flange 23.

By such arrangements, each of the inner spaces 22 of the storage device in accordance with the present invention is capable of accommodating a plurality of screwdriver heads 51, and the screwdriver heads 51 can be taken out via the push portion 24. Therefore, the screwdriver head storage device of the present invention is convenient to use, and the user does not have to replenish new screwdriver heads 51 very frequently, when the screwdriver head storage device is used as a display case.

Referring then to FIGS. 3-5, the base member 30 is provided at a bottom surface thereof with the base chamber 31 which can be used to accommodate the user's belongings. For example, a handle 52 can be put in the base chamber 31, and the handle 52 can be assembled with the screwdriver head to form a handle tool.

While we have shown and described various embodiments in accordance with the present invention, it is clear to those skilled in the art that further embodiments may be made without departing from the scope of the present invention.

What is claimed is:

1. A screwdriver head storage device comprising:
a base formed with a plurality of inner spaces, each of the inner spaces including a bottom and a top, the cover being provided with a stop flange, a push portion, and a lateral opening on the top of each of the inner spaces;
a plurality of elastic members each being received in a corresponding one of the inner spaces and having a first end connected to the bottom of the corresponding one of the positioning portions; and
each of the inner spaces being capable of holding a plurality of screwdriver heads between a top surface of the base member and a second end of the respective elastic members.

2. The screwdriver head storage device as claimed in claim 1, wherein the base includes a cover fixed to a top surface of a base member, the stop flange, the push portion, and the lateral opening are located at a top surface of the cover, the cover is divided into a plurality of chambers by a plurality of separating pieces, when the cover is fixed to the base member, the chambers of the cover are sealed with the top surface of the base member to form the plurality of inner spaces, and a bottom of the inner spaces is the top surface of the base member.

3. The screwdriver head storage device as claimed in claim 2, wherein the base member is provided at a bottom surface thereof with a base chamber, and a pivot member which is pivoted at one side of the base chamber to selectively close or open the base chamber.

4. The screwdriver head storage device as claimed in claim 2, wherein the base member is provided at the top surface thereof with a plurality of positioning portions, and each of the elastic members has a first end connected to a corresponding one of the positioning portions.

5. The screwdriver head storage device as claimed in claim 4, wherein each of the elastic members includes a compression spring and a push member fixed to one end of the compression spring, another end of the compression spring is sleeved onto the positioning portion, and a lateral flat surface of the push member is abutted against the top surface of the inner space.

6. The screwdriver head storage device as claimed in claim 1, wherein the push portion is located at the top of each of the inner spaces, and the stop flange is located at two sides of the push portion.

7. The screwdriver head storage device as claimed in claim 2, wherein the push portion is located at the top of each of the inner spaces, and the stop flange is located at two sides of the push portion.
